(19) United States
(12) Patent Application Publication
(10) Pub. No.: US 2008/0265112 A1
(43) Pub. Date: Oct. 30, 2008

(54) Standoff support system

(75) Inventors: Jesus Pascual, Bristol (GB); Alan R. Bennett, Bristol (GB); Theo Hoekstra, Bristol (GB)

Correspondence Address: NIXON & VANDERHYE, PC, 901 NORTH GLEBE ROAD, 11TH FLOOR, ARLINGTON, VA, 22203, US

(73) Assignee: AIRBUS UK LIMITED, Bristol (GB)

(21) Appl. No.: 12/076,589

(22) Filed: Mar. 20, 2008

(30) Foreign Application Priority Data
Apr. 25, 2007 (GB) GB0708024.5

(51) Int. Cl. F16M 11/00

(52) U.S. Cl. 248/176.1

(57) ABSTRACT

A standoff support system comprises a standoff support including a mounting foot and a body portion, with the body portion having a first engagement portion formed on a free end of it and the further comprising clip tray having a second engagement portion such that the first and second engagement portions are arranged to be engagable with one another and have complementary mating services arranged limit the orientation of the clip tray relative to the standoff support to one or more predefined orientations.

### BACKGROUND OF THE INVENTION

A standoff support system comprises apparatus that allows cables, pipes or similar items to be fixed in a defined spatial relationship to another item of equipment. A typical use of standoff support systems is found within the aerospace industry where standoff supports are used to fix wiring cables and looms, hydraulic pipes or similar items to structural components or sub-components of an airframe.

A typical prior art standoff support comprises a cylindrical post having a flat, circular, foot at one end that is adhesively bonded to an appropriate structural component. At the opposite end of the cylindrical post a threaded hole is provided in axial alignment with the post to which a cable or pipe clip can be screwed. In alternative arrangements the threaded hole is replaced with a threaded stud bonded to the cylindrical post and the cable or pipe clip is bolted to the stud. The clips are typically P-clips, which are known to those skilled in the art.

Two significant problems have been identified with the known prior art standoff supports. Firstly, the cylindrical post is subjected, in normal use, to bending loads applied by the cables or pipes being supported by the standoff support and which may be subject to vibrational or other forces acting upon them. Such loadings can often result in premature failure of the cylindrical post of the support, since a right cylinder is not the strongest possible structure for resisting the applied bending loads. Secondly, the screw thread or threaded bolt provided for fixing the P-clip to the support post allows a certain degree of ambiguity as to what the desired orientation angle of the P-clip with respect to the support post should be and hence introduces an ambiguity in the orientation of the supported cables or pipes. It is desirable that this ambiguity is removed, since the incorrect orientation of a pipe or cable with respect to its supporting component or neighbouring cables or pipes can introduce unintended additional loadings and lead to premature failure of the cables or pipes. It is also desirable to remove any ambiguity in the desired orientation of the cables and pipes, since it is desirable for every aircraft to be constructed as systematically as possible.

### SUMMARY OF THE INVENTION

According to a first aspect of the present invention there is provided a standoff support system comprising a standoff support including a mounting foot and a body portion, the body portion having a first engagement portion formed in the free end thereof, and comprising a clip tray having a second engagement portion, wherein the first and second engagement portions are arranged to be engagable with one another and have complementary mating services arranged to limit the orientation of the clip tray relative to the standoff support to one or more predefined orientations.

Preferably, one of the first and second engagement portions comprises a male engagement member and the other of the first and second engagement portions comprises a female engagement member arranged to receive the male engagement member therein.

Additionally or alternatively, the complementary mating services of the first and second engagement portions may be arranged to prevent relative rotational movement of the standoff support on the clip tray.

Preferably at least a portion of the standoff support body is tapered towards the first engagement portion. Alternatively, the standoff support body may be cylindrical and at least one reinforcing element may be provided extending between the standoff support body and the mounting foot.

Additionally or alternatively, the clip tray may have a lower surface on which the second engagement portion is located and an upper surface including at least one clip receiving area. Each clip receiving area may be defined by one or more raised elements formed on the upper surface. The raised elements may be arranged to restrain a clip mounted on the clip tray in a fixed orientation relative to the clip tray.

Additionally or alternately, the clip tray may include securing means provided to allow one or more clips to be secured to the clip tray. Additionally, each securing means may comprise a fastening bracket provided on the lower surface of the clip tray. Preferably, the fastening bracket is integrally formed with the clip tray.

### DETAILED DESCRIPTION

Some embodiments of the present invention are described below, means of illustrative examples only, with reference to the accompanying Figures, of which:

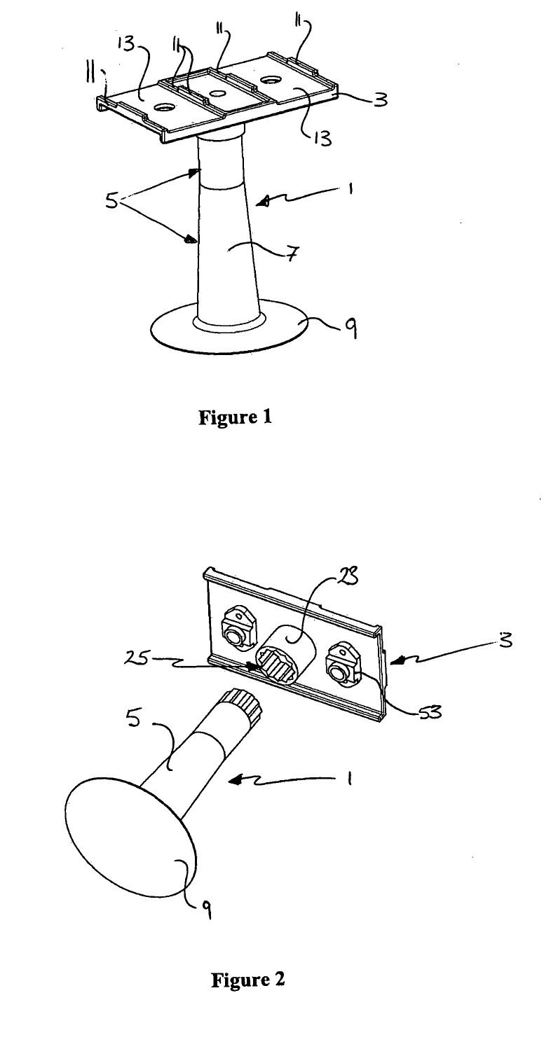

FIG. 1 illustrates a standoff support system according to an embodiment to the present invention;

FIG. 2 illustrates the standoff support and clip tray of the embodiment illustrated in FIG. 1 in an unassembled condition;

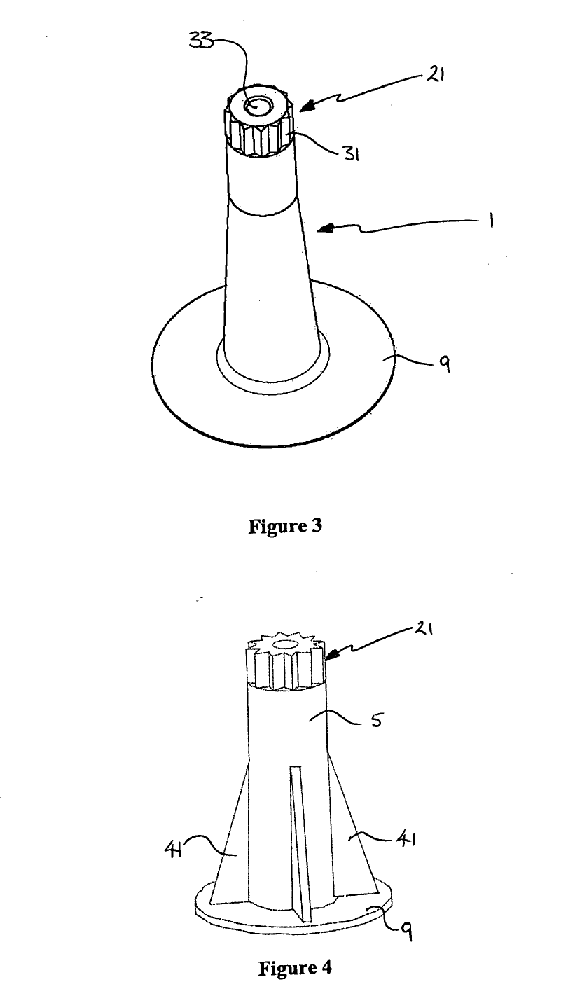

FIG. 3 illustrates an enlarged view of one end of the standoff support shown in FIGS. 1 and 2;

FIG. 4 illustrates an alternative embodiment of a standoff support according to the present invention;

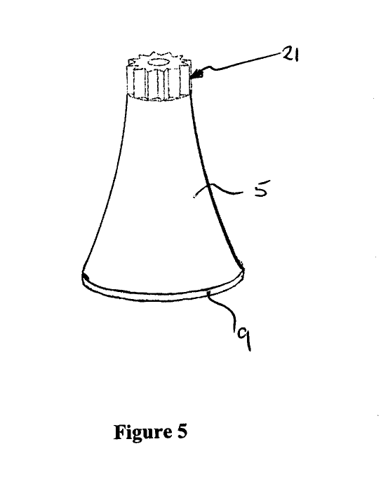

FIG. 5 illustrates a further alternative embodiment of a standoff support according to the present invention;

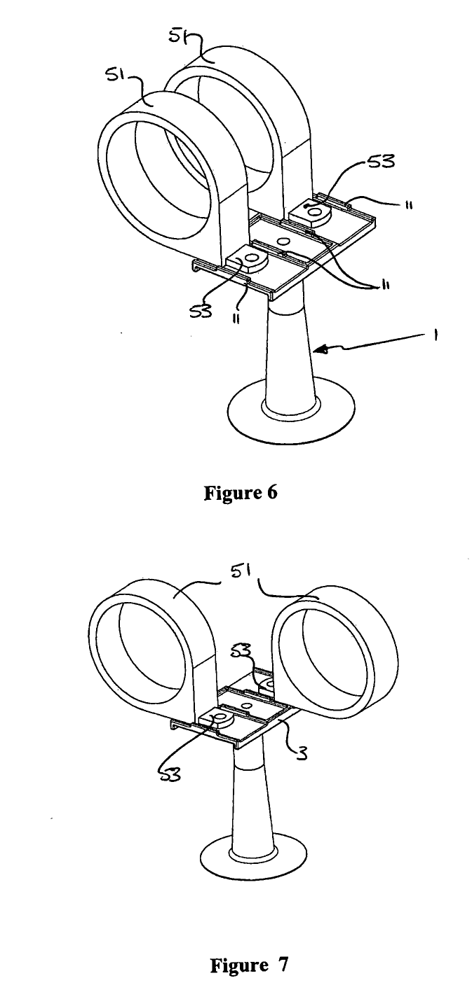

FIG. 6 illustrates a first possible arrangement of P-clips in combination with the standoff support system illustrated in FIG. 1; and

FIG. 7 illustrates a second possible arrangement of P-clips in combination with the standoff support system illustrated in FIG. 1.

A support standoff system according to an embodiment of the present invention is illustrated in FIG. 1 and comprises a standoff support 1 and a clip tray 3 attached to the standoff support. The standoff support has an elongate body section 5, at least a portion of which 7 is semi-conical. At the base of the conical portion 7 of the standoff body 5 there is provided a mounting foot 9 having a substantially flat under surface that is arranged to be adhesively bonded in a manner known to the person skilled in the art to add the desired structural component or sub-component of, for example, an airframe. The mounting foot 9 in the embodiment illustrated in FIG. 1 comprises a circular disk extending from the base of the standoff body 5. However, it will be appreciated by those skilled in the art that the mounting foot 9 may be any other desired shape or configuration provided that it can be securely fixed to the desired structural member. The clip tray 3 comprises a substantially planar member, which is preferably rectangular in outline. A series of transverse raised ridges 11 formed on the upper surface of the clip tray define a number of cable/pipe clip attachment locations. In the embodiment illustrated in FIG. 1 two attachment locations 13 are defined located at the opposite longitudinal ends of the upper surface of the clip tray. A typical cable/pipe clip for use with standoff supports is the known P-clip. For the sake of convenience, reference will be made to a P-clip whenever a generic pipe/cable clip is inferred. It will therefore be understood by person skilled in the art that cable/pipe clips of any kind in addition to the known P-clip may be used in combination with the standoff support system of the present invention.

FIG. 2 illustrates the standoff support body and clip tray of the embodiment of the present invention illustrated in FIG. 1 in a further perspective and with the clip tray 3 and standoff body 1 in a dismantled configuration from one another. From FIG. 2 is can be seen that the free end of the standoff support body 5, that is the end opposite from the mounting foot 9, has a number of ridges or angular projections formed around the periphery of the free end of the support standoff body. The portion of the support standoff body having the shaped ridges or projections formed therein is herein referred to as the first engagement portion 21. The lower surface of the clip tray 3 has a hollow extension 23 formed thereon having a corresponding number of ridges or projections formed on the inside surface of the hollow projection such that the inside surface of the projection 23 and the peripheral surface of the first engagement portion 21 on the support standoff body are complementary to one another in shape. The projection 23 formed on the lower surface of the clip tray is referred to hereinafter as the second engagement portion 25. The complementary configuration of the first and second engagement portions 21, 25 is such that the first engagement portion 21 of the support standoff body 5 can be brought into engagement with the second engagement portion 25 of the clip tray. An alternative view of the first engagement portion 21 of the standoff support 1 is illustrated in FIG. 3. In the particular embodiment illustrated the shaped ridges or protrusions comprise triangular “teeth” 31 that are uniformly distributed about the circumference of the standoff support body. The number of teeth 31 defines the number of angular orientations relative to the standoff support body 1 in which the clip tray 3 can be mounted to the standoff support body. By varying the number of teeth 31 provided in the first engagement portion 21 of the standoff support the number of possible orientations of the clip tray can be correspondingly varied. In some embodiments a reference marker (not illustrated) may be formed on both the standoff support and the clip tray that are arranged to be aligned with one another when the clip tray is mounted to the standoff support in what may be designated a “home” position or at an arbitrarily defined 0° of orientation. This then allows that the required degree angle orientation of the clip tray to the standoff support to be specified in, for example, the assembly drawings used by the airframe fitters/assemblers, such that it can be defined that a particular clip tray be mounted at, for example, +45° to the designated zero position relative to the standoff support. In addition to allowing the definition of a preset number of relative orientations of the clip tray to the standoff support, the provision of the teeth 31 on the standoff support also provides a greater security of attachment of the clip tray 3 to the standoff support 1, since any load forces applied to the clip tray 3 can be transmitted through the greater surface area of the teeth 31 in comparison with the prior art standoff supports that have a smooth, continuous outer surface at their points of connection to corresponding P-clip. It will also be appreciated that the triangular shape of the teeth 31 illustrated in FIGS. 2 and 3 is merely one possible configuration for the first engagement portion 21 and any appropriate arrangement and shape of teeth, such as rectangular keys in corresponding keyways or semi circular dogs, may be envisaged by those skilled in the art without extending beyond the scope of the present invention. Furthermore, in other embodiments the first engagement portion 21 may simply have a shape that prevents rotation of the clip tray relative to the standoff body. For example, the first engagement portion may be hexagonal in shape or semi-circular. It will be appreciated that the first and second engagement portions may be of any complementary shape or configuration that prevents relative rotation between them. It will also be appreciated by those skilled in the art that in further embodiments of the present invention the second engagement portion 25 formed on the clip tray 3 may comprise a projecting stud having the teeth mounted on its external surface and arranged to engage within a correspondingly shaped socket provided as the first engagement portion 21 at the free end of the standoff support body 5. In other words, whereas the clip tray 3 shown in FIG. 2 is configured with a “female” engagement portion with a corresponding “male” engagement portion on the standoff support, in other embodiments of the present invention it may equally be the case that the clip tray 3 has a male engagement portion formed thereon, while the standoff support has a female engagement portion formed thereon.

Finally, in the particular embodiment illustrated in FIG. 3, a threaded hole 33 is formed in the open end of the standoff support body 5, in axial alignment of the central axis of the standoff support body in a manner known to those skilled in the art. This allows a threaded screw to pass through a corresponding hole formed in the clip tray 3 as such that the clip tray may be secured to the standoff support using the threaded screw. In alternative embodiments, and as will be known and appreciated by those skilled in the art, a threaded stud may be provided protruding from the end of the standoff support that is arranged to pass through a corresponding hole in the clip tray and receive a correspondingly threaded nut that secures the clip tray 3 to the standoff support 1.

An alternative embodiment of a standoff support according to the present invention is illustrated in FIG. 4. In this particular embodiment the standoff support body 5 is cylindrical in cross-section over its entire length, with the exception of the first engagement portion 21 formed at the free end of the standoff support body 5. As with the embodiments illustrated in FIGS. 1 to 3, a mounting foot 9 preferably comprising a circular disk is formed on the opposite end of the standoff support body 5 at approximately 90° to the longitudinal axis of the standoff support body. However, in contrast to the known prior art standoff supports, a number of reinforcing fillets 41 extend between the mounting foot 9 and a portion of the cylindrical standoff support body 5. In the embodiment illustrated in FIG. 4 the reinforcing fillets 41 are triangular in shape but it will be appreciated that other shapes may be utilised. The reinforcing fillets 41 reinforce the cylindrical standoff support body 5 against any bending loads applied to it. Whilst this arrangement is an improvement over the plain cylindrical standoff supports known in the prior art, the increase in strength for the given increase in material weight is not as advantageous as for the semi-conical standoff support body portion utilised in the embodiments of the present invention illustrated in FIGS. 1 to 3.

In a further embodiment of the present invention, not illustrated, the standoff support body 5 may comprise two or more cylindrical portions of differing diameters, with the portion having the greater diameter being located adjacent to the mounting foot 9 and there being a stepped change in diameter between the two different portions. The portion or portions having the greater diameter will have a greater resistance to any bending forces applied to them than the portions having the smaller diameter and in this way some of the increased strength characteristics provided by the semi-conical arrangement shown in FIGS. 1 to 3 may be provided.

In a yet further embodiment illustrated in FIG. 5 the standoff support body 5 is bell shaped, with the diameter of the standoff support body decreasing from the base towards the first engagement portion such that the outer profile describes a continuous curve. In the embodiment illustrated in FIG. 5 the diameter of the base of the standoff support body equals the diameter of the mounting foot 9. However, it will be appreciated by the skilled person that the diameter of the mounting foot may be greater than that of the support body 5.

The present invention includes other embodiments in which the standoff support body 5 tapers towards the first engagement portion 21. Although it preferable for the standoff support body 5 to be circular in cross section it is not essential and other geometries may be adopted if required.

FIG. 6 illustrates an embodiment of the support standoff system according to the present invention in combination with a pair of standard P-clips. Each P-clip 51 is secured to the clip tray 3 and is located within a respective clip receiving portion of the clip tray 3 that is defined by the upwardly extending ridges 11 formed on the upper surface of the clip tray. The ridges 11 are spaced apart a distance corresponding to the width of the P-clip 51 such that each P-clip is restrained in a pre-defined orientation to the clip tray 3. As illustrated in FIG. 7, each P-clip 51 can be mounted in one of two orientations with respect to the clip tray 3, thus providing a flexibility in the use of the standoff support system of the present invention. Each P-clip 51 is secured to the clip tray 3 by means of an attachment means passing through a hole provided in the conventional fixing lug 53 of the P-clip. The attachment means may be a conventional threaded screw or bolt that passes through the fixing lug 53 of the P-clip and screws into a correspondingly threaded hole formed in the clip tray 3. In preferred embodiments of the present invention P-clip attachment anchors are provided on the underside of the clip tray 3, as best illustrated in FIG. 2. Each attachment anchor 55 may be secured or bonded to the lower surface of the clip tray 3 by any conventional process, or may alternatively be moulded integrally with the clip tray. Each attachment anchor 53 includes a threaded hole arranged to receive the threaded screw, or the like, extending through the fixing lug 53 of the P-clip. For example, the threaded hole may be a form using a conventional helical insert. Other fixing mechanisms such as corresponding nuts bonding to the underside of the clip tray may also be utilised in alternative embodiments of the present invention.

The provision of the correspondingly shaped first and second engagement portions on the standoff support and clip tray of the standoff support system according to embodiments of the present invention allow the clip tray to be mounted in a number of predefined orientations which respect to the standoff support, whilst at the same time providing improved transmission of load forces through the clip tray to the standoff support in comparison with standoff supports known from the prior art.

1. A standoff support system comprising:
a standoff support including a mounting foot and a body portion, the body portion having a first engagement portion formed on a free end thereof; and
a clip tray having a second engagement portion, wherein the first and second engagement portions are arranged to be engagable with one another and have complementary mating surfaces arranged to limit the orientation of the clip tray relative to the standoff support to one or more predefined orientations.

2. A standoff support system according to claim 1, wherein one of the first and second engagement portions comprises a male engagement member and the other of the first and second engagement portions comprises a female engagement member arranged to receive the male engagement member therein.

3. A standoff support system according to claim 1, wherein the complementary mating surfaces of the first and second engagement portions are arranged to prevent relative rotational movement of the standoff support and the clip tray.

4. A standoff support system according to claim 1, wherein at least a portion of the standoff support body is tapered towards the first engagement portion.

5. A standoff support system according to claim 1, wherein the standoff support body is cylindrical and at least one reinforcing element is provided extending between the standoff support body and the mounting foot.

6. A standoff support system according to claim 1, wherein the clip tray has a lower surface on which the second engagement portion is located and an upper surface including at least one clip receiving area.

7. A standoff support system according to claim 6, wherein each clip receiving area is defined by one or more raised elements formed on the upper surface.

8. A standoff support system according to claim 7, wherein the raised elements are arranged to restrain a clip mounted on the clip tray in a fixed orientation relative to the clip tray.

9. A standoff support system according to claim 6, wherein the clip tray includes securing means provided to allow one or more clips to be secured to the clip tray.

10. A standoff support system according to claim 9, wherein each securing means comprises a fastening bracket provided on the lower surface of clip tray.

11. A standoff support system according to claim 10, wherein the fastening bracket in integrally formed with the clip tray.
